(19) United States
(12) Patent Application Publication
(10) Pub. No.: US 2015/0206075 A1
(43) Pub. Date: Jul. 23, 2015

(54) Efficient Decision Making

(71) Applicant: International Business Machines Corporation, Armonk, NY (US)

(72) Inventors: Pierre D. Feillet, Gentilly (FR); Pierre-Andre Paumelle, Soisy Sur Seine (FR)

(21) Appl. No.: 14/573,364

(22) Filed: Dec. 17, 2014

(30) Foreign Application Priority Data
Jan. 23, 2014 (GB) 1401127.4

(51) Int. Cl. G06Q 10/06

(52) U.S. Cl. CPC G06Q 10/063

(57) ABSTRACT

A mechanism is provided for making a decision in a service oriented architecture. A request is received for a decision service, the request comprising a plurality of user-defined parameters. A key is generated based on the relevant parameters in the plurality of user-defined parameters. The relevant parameters are parameters to be used by a rule set in making the decision. The rule set is used to make the decision. The key and the decision is stored in a cache. The decision is then returned to a source of the request.

### BACKGROUND

The present invention relates generally to an improved data processing apparatus and method and more specifically to mechanisms for making a decision in a service oriented architecture.

Decision management is a business discipline that empowers organizations to automate, optimize, and govern repeatable business decisions, Decision management technology provides the means for these decisions to be automated and called in real time by processes, applications, and other business solutions.

Decision management technology for instance facilitates decision-making in a service-oriented architecture (SOA) such as the provisioning of services over the Internet, in which a decision making automaton is configured as a service to make such business decisions based on requests received from (remote) clients. For example, a bank may provide a decision making automaton that decides if a request for a loan received from a client should be granted; an insurance company may provide a decision making automaton that decides whether or not a request for a car insurance received from a client can be safely underwritten, and so on.

To realize such automation, the technology must make it possible to capture, change, and deploy the required decision logic in a controlled, scalable, and rapid manner. The decision logic is typically implemented by a set of rules, which reach the decision based on parameters in the client request, such as income and loan amount in the aforementioned bank example. However, depending on the complexity of the decision logic, such a decision making process can be resource and time consuming.

It is therefore desirable to introduce some form of reusability in such decision making processes, as such reusability can lead to a cost saving in terms of resource use and/or computation time. It is for instance well known to store the decision engine including the rule set for making the decision in a cache of a computer system arranged to execute the decision engine. This reduces the overhead required to load and run the decision engine, but this reduction can be rather modest, especially when the computational effort required to make the decision dominates the overall cost of the decision making process.

The Internet article “XACML Caching for Performance” by Anil Saldhana recognizes that for identical XACML requests in an XACML access control decision making process, the Policy Decision Point (PDF) will lead to identical responses. Such responses (decisions) may be stored in a decision cache such that access to the system may be more rapidly granted upon detection of an identical access request. Cache hit rates may be improved by hardcoding the cache evaluation logic to ignore certain elements in the access request such as the time of an access request. This however is not without risk, as it requires detailed knowledge of which parameters in the access request can be ignored without compromising the security of the system to be accessed.

There exists a need for improving the efficiency of such decision making processes, in particular business decision making processes, without jeopardizing the robustness of the decision making process.

### SUMMARY

In one illustrative embodiment, a method, in a data processing system, is provided for making a decision in a service oriented architecture. The illustrative embodiment receives a request for a decision service. In the illustrative embodiment, the request comprises a plurality of user-defined parameters. The illustrative embodiments generate a key based on relevant parameters in the plurality of user-defined parameters. In the illustrative embodiment, the relevant parameters are parameters to be used by a rule set in making the decision. The illustrative embodiment uses the rule set to make the decision, stores the key and the decision in a cache, and returns the decision to a source of the request.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

Preferred embodiments of the present invention will now be described, by way of example only, with reference to the following drawings, in which:

FIG. 1 schematically depicts a data processing system according to an embodiment of the present invention;

FIG. 2 schematically depicts the functionality implemented by the data processing system of FIG. 1;

FIG. 3 schematically depicts a flowchart, of an aspect of a method according to an embodiment of the present invention; and

FIG. 4 schematically depicts a flowchart of another aspect of a method according to an embodiment of the present invention;

FIG. 5 schematically depicts a flow diagram of messages in the data processing system of FIG. 1;

FIG. 6 schematically depicts a data processing system according to another embodiment of the present invention;

FIG. 7 schematically depicts the functionality implemented by the data processing system of FIG. 6;

FIG. 8 schematically depicts a flowchart of an aspect of a method according to another embodiment of the present invention; and

FIG. 9 schematically depicts a data processing system according to yet another embodiment of the present invention.

### DETAILED DESCRIPTION

It should be understood that the Figures are merely schematic and are not drawn to scale. It should also be understood that the same reference numerals are used throughout the Figures to indicate the same or similar parts.

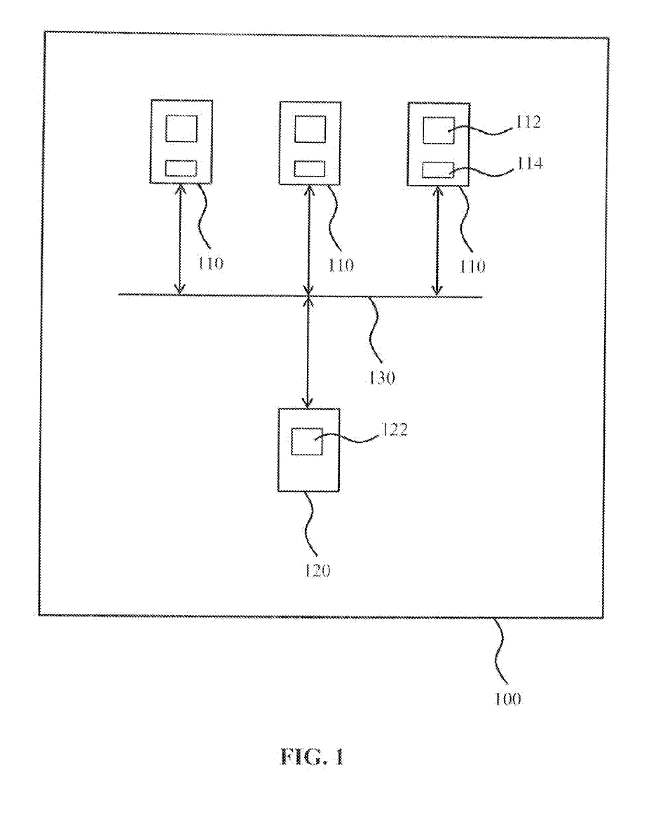

FIG. 1 schematically depicts a data processing system 100 according to an embodiment of the present invention, which data processing system 100 implements a service-oriented architecture. The data processing system 100 is shown as a distributed architecture comprising one or more clients 110 and a server 120 configured to deliver a service to a client 110 upon receiving a request for such a service from a client 110. Such a request may be communicated between the client 110 and the server 120 in any suitable form, e.g. in the form of a message as is well-known per se. Similarly, the response to the request may be delivered to the client 110 by the server 120 in any suitable form such as a message.

In such a distributed architecture, the clients 110 and the sender 120 may be communicatively coupled to each other by any suitable network 130, e.g. a private network such as a (V)LAN or a wired or wireless public network such as the Internet, a mobile communications network employing 3G, 4G, 5S standards, and so on. It should however be appreciated that in some embodiments, the data processing system 100 may be implemented on a single physical device, wherein the clients 110 and the server 120 for instance may be implemented as the virtual servers on the single physical device. The particular realization of the service-oriented architecture in hardware is not particularly critical to the present invention and any suitable implementation may be chosen.

In FIG. 1, the clients 110 comprises (or have access to) a processor 112 and a cache 114. The cache 114 is used as a decision cache as will be explained in more detail below. The server 120 comprises (or has access to) a processor 122. In embodiments of the present invention, the server 120 is configured to deliver a decision making service, in particular a business decision making service. The processor 122 is configured to implement this decision making service, for instance by executing a rule engine that utilizes a set of rules. In a typical scenario, a client 110 will receive a request for a decision from a user, which user will specify a number of parameters in the request. Such parameters can typically be split into two categories. The first category of parameters is relevant to the identity of the user, e.g. name, address, telephone number, employer, age and so on. The second category of parameters is relevant to the decision making process, i.e. these are the parameters used by the rule engine to reach a decision. For instance, in the present application the example of requesting a bank loan will be used as a non-limiting example to explain the invention in more detail. In such a scenario, parameters relevant to the decision-making process will include annual income, loan amount, term of the loan, annual interest rate and so on. Obviously, many other parameters relevant to a decision-making process will exist; for instance, a user requesting a car insurance quote will typically have to specify user age, card details, accident history details and so on in order for the rule engine to generate a decision for an insurance broker. Many other business decision making scenarios with many other relevant parameters will be apparent to the skilled person.

It is of course well-known per se to design such rule engines. The design of such rule engines is beyond the scope of the present application and will therefore not be explained in further detail for the sake of brevity only.

As also mentioned in the background section, such rule engines may be required to make complex decisions, which can have the consequence that the decision making process can be rather costly in terms of resource use as well as in terms of duration of the decision making process. Embodiments of the present invention target of improvement in the efficiency of such decision making processes by reducing resource use and duration of the decision-making process wherever possible. In particular, embodiments of the present invention are based on the insight that decisions that have been generated from a specific set of parameters relevant to the decision will be reproduced if the same set of parameters occurs in a subsequent request for a decision. This is particularly the case if the rule engine acts as a stateless deterministic automaton, because such automata will always produce the same decision for a particular set of relevant parameters.

This insight is utilized by storing decisions made by the rule engine in the cache 114 and identifying the decisions by a key, which has been generated from the specific relevant parameters used to make the decision. In other words, the cache 114 contains tuples of such generated keys and the decisions made using these relevant parameters. Specifically, the key is generated using only the parameters relevant to the decision making process, i.e. discarding the parameters that do not drive the decision making process, e.g. parameters that are unique to a particular user, e.g. user identification parameters. The key may be generated using any suitable key generation algorithm. Key generation is well-known per se and will not be explained in further detail for the sake of brevity only.

As will be appreciated, in order to determine which of the parameters in a request are relevant to the decision making process, it is necessary for the entity responsible for generating the key to have knowledge of which parameters are such relevant parameters. This for instance may be achieved by statically analyzing the business rules used by the rule engine to reach a decision to identify which parameters are being used by the rule engine in the decision making process. This for instance may be achieved by an automated static analysis to detect what are the determining and non-determining parameters of the service signature by scanning the rule conditions and actions as defined in the relevant rule set. Such scanning may for instance be implemented by computation of the causal relationship between input parameters and output parameters produced by the rules.

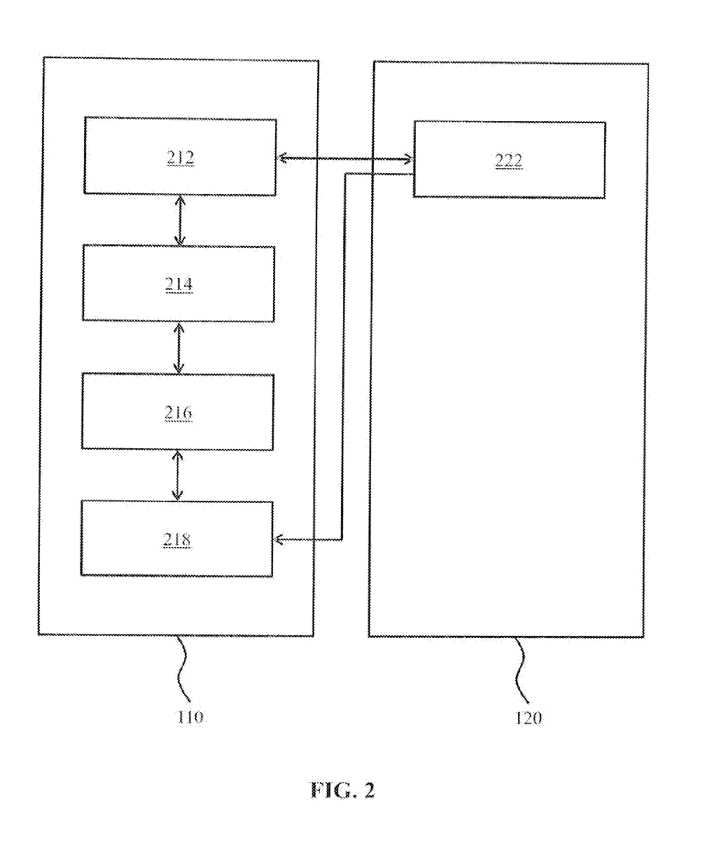

A non-limiting example of the mapping of the various tasks required to implement caching of decisions for reuse is shown in FIG. 2. At the client 110, a rule set analyzer 212 may be provided. The rule set analyzer 212 is a component that is used when a rule set is authored and/or deployed for execution by the rule engine. The rule set analyzer 212 for instance may statically evaluate the rule set including the decision service signature, i.e. a list identifying parameters by name, type and direction (input, output, input & output), to determine the set of parameters that are relevant to the decision making process. These parameters will be referred to as the relevant parameters in the remainder of this application. The parameters that are not relevant to the decision making process, i.e. parameters that do not drive the decision making process will be referred to as irrelevant parameters in the remainder of this application. For example, irrelevant parameters may be parameters that identify a particular user (a particular request source) although other types of irrelevant parameters will of course be equally feasible.

The rule set analyzer 212 may generate a decision request filter 214 based on the deduced set of relevant parameters, which decision request filter 214 is adapted to receive a request for a decision and filter the relevant parameters from this request. The decision request filter 214 may pass the extracted relevant parameters to the key generator 216, which generates the key from the extracted relevant parameters using any suitable key generation algorithm as previously explained. The key generator 216 is arranged to pass the generated key onto a decision response filter 218, which is further adapted to receive a decision from rule engine 222 on the server 120 and to create a tuple of the key and the decision for storage in in the cache 114. The decision response filter 218 may filter the received decision, e.g. by removing (irrelevant) parameters from the decision message prior to creating the tuple in order to achieve a more compact cache entry. As will be understood, the key in the tuple acts as an identifier for the decision in the cache entry. At this point it is noted that the decision request filter 214, key generator 216 and the decision response filter 218 may be components generated by the rule set analyzer 212 following completion of the analysis of the rule set. Although the rule set analyzer 212 is shown as being embodied by the client 110, this is by way of non-limiting example only; it is equally feasible that the ride set analyzer 212 does not form part of the system 100 but merely provides the decision request filter 214, key generator 216 and the decision response filter 218 to the system 100 as will be explained in more detail later.

It will be understood that the decision may be stored in the cache 114 in any suitable form. For instance, the decision may be stored in the form of a message further comprising a reason for the decision as well as the parameters received in the original decision request. In an embodiment, the irrelevant parameters may be replaced by wild cards when storing the decision in the cache 114 such that when the decision is reused the wild cards may simply be replaced by the irrelevant parameters of a subsequent decision request having the same relevant parameters (i.e. the same key) as the decision stored in the cache 114.

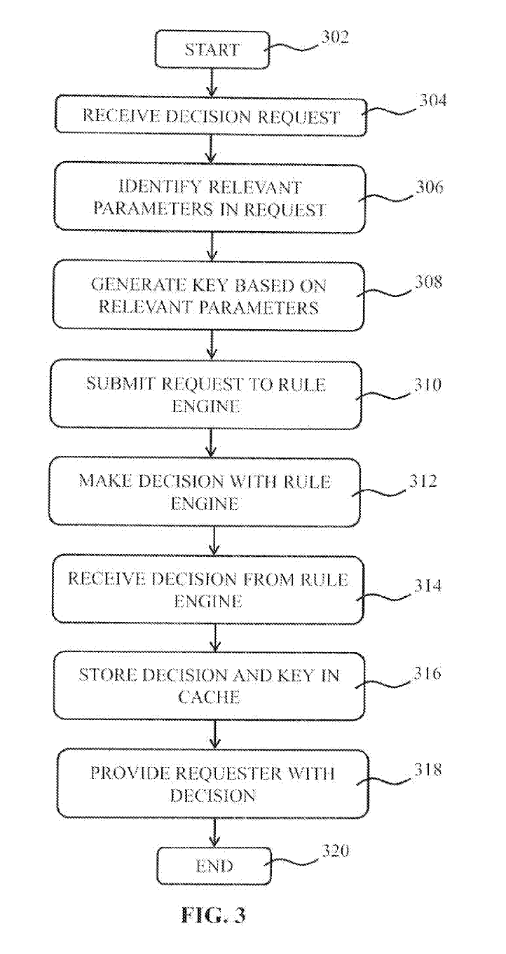

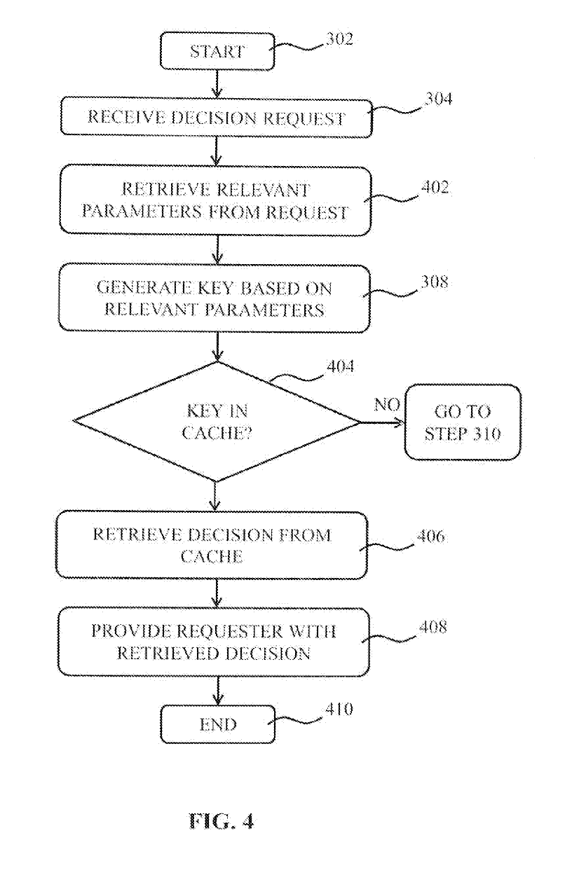

The arrangement shown in FIG. 1 and FIG. 2 may implement a method as depicted by the flow charts in FIGS. 3 and 4 respectively. It is to be understood that these flowcharts show different aspects of the same method. The method typically starts in step 302, e.g. by initializing the data processing system 100, after which the method proceeds to step 304 in which a client 110 receives a decision request from a source. For instance, the client 110 may be a web client hosting a webpage allowing visitors to formulate such requests from their computers by filling out forms on the webpage, after which the client 110 receives the request when the website visitor submits his request.

The method then proceeds to step 306, in which the decision request filter 214 identifies the relevant parameters in the request and extracts these parameters from a request for key generation. This step 306 may further comprise the determination of which parameters are relevant by invoking the rule set analyzer 212 as previously explained. The extracted relevant parameters are then passed onto the key generator 216, which generates the key based on the extracted relevant parameters in step 308.

In case the cache 114 does not (yet) comprise a decision identified by this key, the method proceeds to step 310 in which the client 110 forwards the decision request to the server 120. Upon receiving the request, the server 120 invokes the rule engine and applies the rule set to the relevant parameters in step 312 to reach a decision. This decision is subsequently returned to the client 110 in step 314 where the decision is passed onto the decision response filter 218, which filters the relevant portions from the decision, and optionally places wild cards in the decision to replace irrelevant parameters as previously explained, after which the filtered decision together with its corresponding key is placed in the cache 114 in step 316. The decision is returned to the originator or source of the request in step 318, e.g. by e-mail, by displaying the decision or a computer screen of the originator, and so on. The method then terminates in step 320.

As explained above, the aspect of the method as shown in FIG. 3 is applicable when receiving a decision request for the first time, i.e. when the cache 114 is empty. FIG. 4 depicts a flowchart of the method when the cache 114 comprises one or more entries containing different key-decision tuples. As before, a client 110 receives a decision request in step 304, the relevant parameters are extracted from the request in step 306 and the key is generated from the relevant parameters in step 308 as explained in more detail above.

Next, the method proceeds to step 404 in which it is checked if the key generated for the new request already exists in cache 114. If the key is not present in cache 114, this signals the client 110 that the cache 114 does not contain a decision that can be reused for the current request. Consequently, the method proceeds to step 310 as explained in more detail with the aid of FIG. 3, in which a new decision is being generated by the rule engine on the server 120, which decision is subsequently returned to the client 110, stored in the cache 114 together with its key and returned to the requester of the decision as previously explained.

On the other hand, if it is decided in step 404 that the key generated for the new request already exists in the cache 114, the method proceeds to step 406 in which the corresponding decision is retrieved from the cache 114 and returned to the requester of the decision in step 408, before terminating the method in step 410. Before returning to decision to the requester, the wild cards in the retrieved decision if present may be replaced with the corresponding (irrelevant) parameters in the decision request received in step 304, such that the requester can readily recognize that the decision corresponds to his or her request. As demonstrated by the flow chart of FIG. 4, in case a decision may be retrieved from the cache 114, the client 110 does not have to engage in communications with the server 120 and indeed does not have to invoke the decision making process on the server 120, thereby significantly reducing the computational effort required to reach the decision.

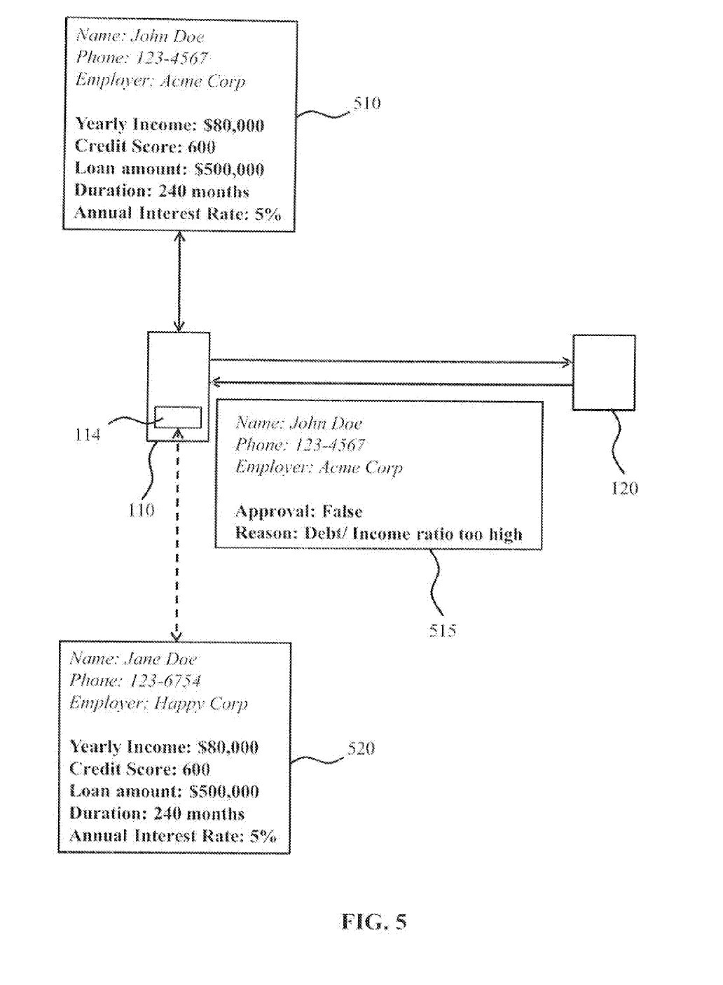

FIG. 5 schematically depicts an example of a message flow as it may occur in a data processing system 100 according to an embodiment of the present invention. A client 110 may receive a request 510 from a John Doe, who is interested in taking out a loan with a bank, which bank hosts a decision making service on the server 120, i.e. the server 120 hosts a rule engine configured to decide whether an application for a loan can be approved. To this end, the request 510 typically comprises a set of irrelevant parameters, that is, parameters irrelevant to the decision making process, which are shown in italic, and a set of relevant parameters, that is, parameters relevant to the decision-making process, which are shown in bold.

The client 110 checks by generation of a key for the relevant parameters in request 510 if a decision based on these parameters has previously been made. As this is not the case for request 510, the client 110 forwards the request 510 to the server 120, where a decision 515 is generated using the rule engine 222 and returned to the server 110, which stores the decision 510 together with its corresponding key in the cache 114 and returns the decision 515 to John Doe. The communication pathways taken as a result of the request 510 are shown by the solid arrows in FIG. 5.

The client 110 subsequently receives a decision request 520 for a loan from Jane Doe. Although the irrelevant parameters for Jane Doe are different to those of John Doe in request 510, the relevant parameters in request 520 are identical to the relevant parameters in request 510. Consequently, the key generated by client 110 for request 520 is identical to the key previously generated for request 510. Therefore, the client 110 will find a hit in the cache 114 for the key of request 520 and will retrieve the corresponding decision from the cache 114 and return this decision to Jane Doe without having to communicate with the server 120, as indicated by the dashed arrow in FIG. 5, which identifies the communication paths between Jane Doe, more specifically the network device used by Jane Doe, and the client 110.

At this point, it is noted that instead of using the actual values of the relevant parameters to calculate the key in step 308, in at least some embodiments at least some of the relevant parameters may be mapped onto parameter ranges in order to increase the hit rate of the cache 114. For instance, in the example shown in FIG. 5, the parameter “Yearly Income” may be converted into a score corresponding to a suitable range, which ranges and scores may be defined using business rules. An example of such a conversion table is shown in Table 1:

TABLE 1

| Income Band | Score |
|---|---|
| <$40,000 | 1 |
| $40,000-$44,999 | 2 |
| $45,000-$49,999 | 3 |
| $50,000-$54,999 | 4 |
| $55,000-$59,999 | 5 |
| $60,000-$64,999 | 6 |
| $65,000-$74,999 | 7 |
| $75,000-$84,999 | 8 |
| >$85,000 | 9 |

By using such ranges or bands, the cache hit rate can be increased. Obviously, the use of such ranges or bands can have an impact on the accuracy of the decision making process and should therefore only be used where the business rules allow a certain degree of tolerance in the decisions.

As has been explained above, an advantage of the data processing system 100 is that communication with the server 120 can be avoided altogether in case the appropriate decision is already present in the cache 114. The consequence of this implementation is that because the clients 110 locally store these decisions, each client must maintain a local cache 114 in order to have access to these decisions. Although it is possible in principle to synchronize the contents of the respective local caches 114 using suitable synchronization routines, this is not always practically feasible because different clients 110 may not be aware of each other's existence or may not wish to communicate with each other for certain reasons. This therefore does not achieve optimal decision reuse efficiency, because a prior decision may be present in the cache 114 of a first client 110 that has identical relevant parameters to a decision request received by a second client 110, which second client is unaware of the existence of this prior decision because the decision is not stored in its own cache 114.

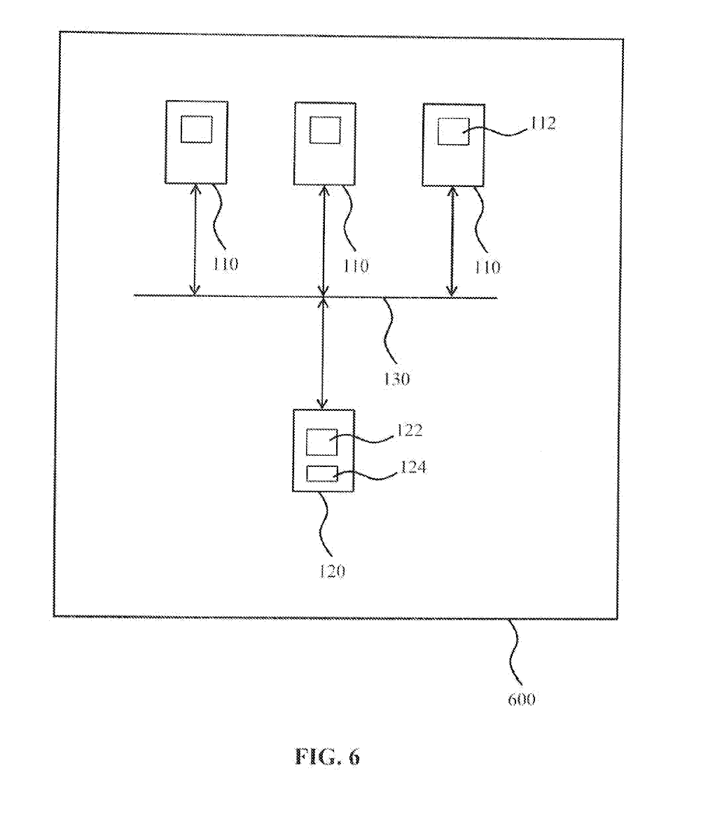

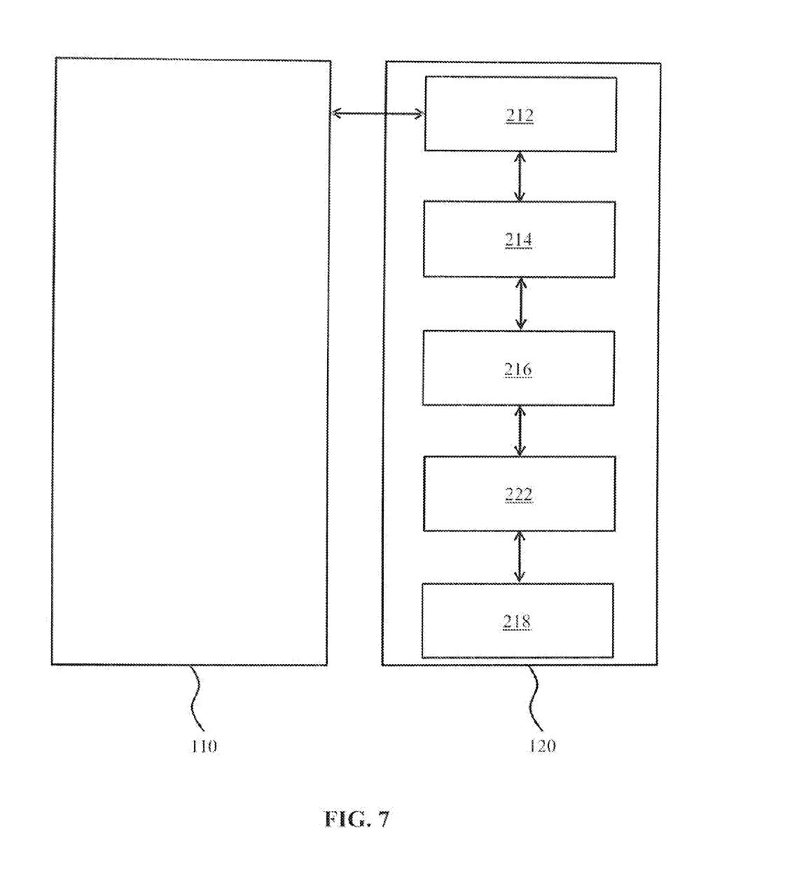

An embodiment of the data processing system in which decision reuse is optimized is shown in FIG. 6, which schematically shows a data processing system 600. The data processing system 600 is identical to the data processing system 100 apart from the fact that the clients 110 do not comprise local decision caches 114, but instead the server 120 is equipped with a decision cache 124. As will be readily understood by the skilled person, this embodiment therefore requires relocation of the functionality on the client 110 that was explained in more detail with the aid of FIG. 2 to the server 120. This remapping is shown in FIG. 7.

In particular, the client 110 no longer comprises the rule set analyzer 212, the decision request filter 214, the key generator 216 and the decision rule filter 218, as these modules are now located on the server 120. As before, the rule set analyzer 212 may alternatively be located elsewhere as will be explained in more detail below. Consequently, the client 110 acts as a conventional client and simply forwards the decision request to the server 120, which is configured to extract the relevant parameters from the decision request and generate the key from these relevant parameters as previously explained. The server 120 will be further configured to search the cache 124 in order to match the generated key with a previously stored key and corresponding decision. In the absence of such a match, the server 120 will invoke the rule engine 222 to make the decision, pass it onto the decision rule filter 228 for storage in the cache 124. The server 120 is further configured to return the decision to the client 110 for passing the decision onto the source of the request as previously explained.

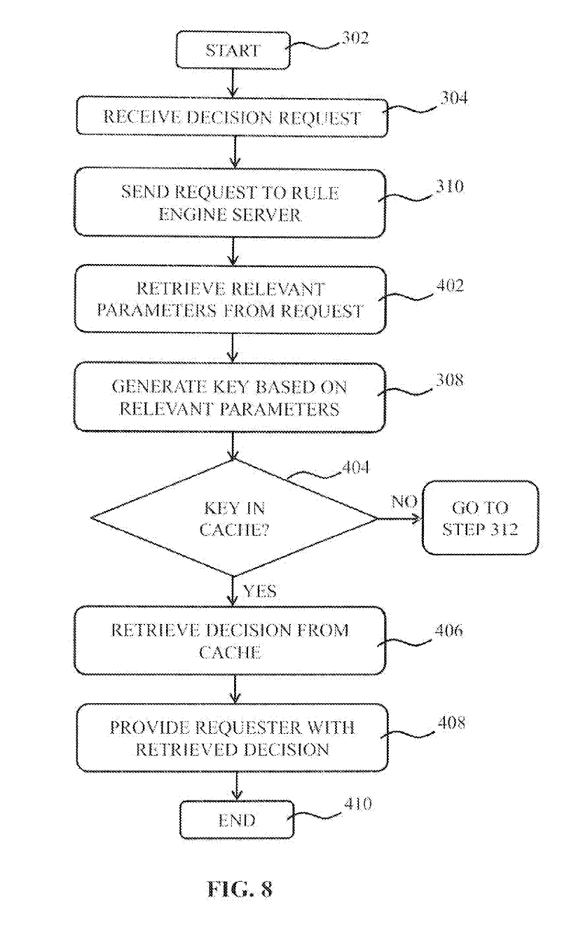

FIG. 8 depicts a flowchart of an embodiment of the method of the present invention, which has been altered to accommodate the infrastructure chosen in the data processing system 600. The steps 302, 304, 306, 308 and 310 may be identical to the steps already explained in detail with the aid of FIG. 3 and FIG. 4 such that these steps will not be explained again for the sake of brevity, although it is noted that in the present embodiment step 310 typically is performed before step 306. This is because evaluation step 306 and subsequent key generation step 308 now are performed on the server 120 rather than on the client 110 as was the case in the previous embodiment, due to the decision cache 124 being located on the server 120, as explained above.

Consequently, steps 306, 308 and 404 are now performed on the server 120 after the decision request is received from the client 110 in step 310. If no matching key is found in cache 124, the method proceeds to step 312 shown in FIG. 3 in which the rule engine 222 of the server 120 is invoked to make the decision based on the request received from the client 110. It is noted for the sake of completeness that in contrast to the embodiment shown in FIG. 3, step 316 will be performed on the server 120 rather than on the client 110 because in the present embodiment the decision cache 124 is located on the server 120 as previously explained. If on the other hand the key generated for the current request matches a key stored in cache 124, the method proceeds to step 406 in which the server 120 retrieves the corresponding decision from the decision cache 124 and returns the retrieved decision to the client 110, which client subsequently may pass on the decision to the requester of the decision in step 408 prior to termination of the method in step 410. If required, the server 120 may replace wildcards in the decision received in step 406 with the corresponding parameters retrieved from the decision request in step 306, e.g. parameters that are unique to the requester of the decision, prior to forwarding the decision to the client 110.

In this embodiment, because the decision cache 124 is located on the server 120, the hit rate of the cache 124 is improved because ail cached decisions are kept in a single location, contrary to the embodiment of the data processing system 100 shown in FIG. 1. However, this comes at a cost of increased data traffic between the clients 110 and the server 120 because the clients 110 must forward each decision request together with a key to the server 120 and the server 120 must communicate every decision to the appropriate client 110 irrespective of whether a reusable decision is available. This therefore increases the workload of the server 120 in terms of data communication, but will reduce the workload of the server 120 because more decisions can be reused.

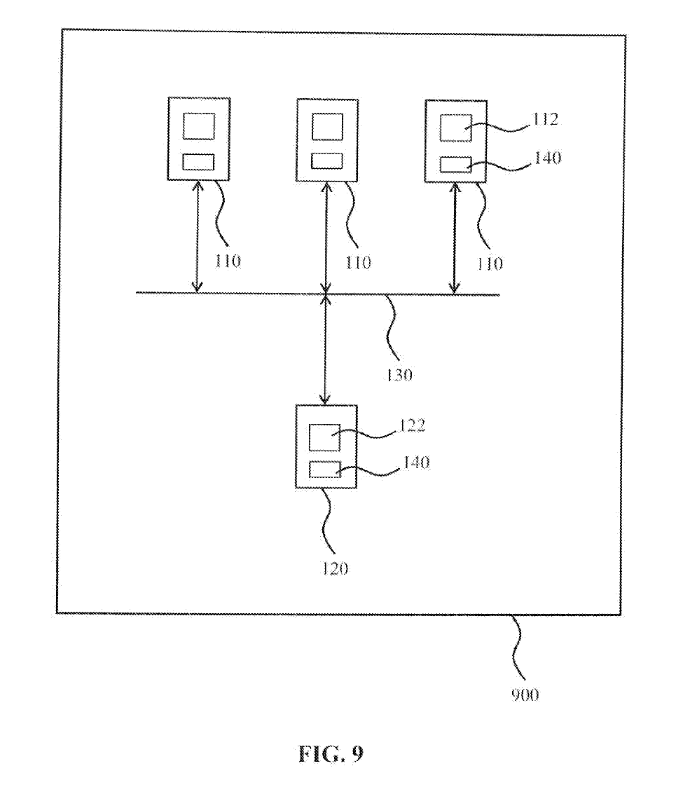

FIG. 9 schematically depicts yet another embodiment of a data processing system 900. In this embodiment, the data processing system 900 comprises a distributed decision cache 140, which is distributed between the clients 110 and the server 120. The direct consequence of this architecture is that cached decisions are present both at the client side as well as the server side. This therefore facilitates improved reusability of decisions, i.e. a greater cache hit rate, as provided by the data processing system 600, and combines this with a reduction in data traffic between clients 110 and server 120 because the only data that needs to be communicated between these entities is cache entries to ensure that each client 110 has a local copy of a decision and its corresponding key in its portion of distributed cache 140. This therefore is an attractive embodiment in service-oriented architectures in which the implementation of such distributed caches 140 is available and feasible, as a drawback of such distributed caches 140 is that they are relatively complex and expensive. In this embodiment, it is particularly advantageous if the key generation is performed by the clients 110 such that communication with the server 120 can be avoided altogether in some scenarios as previously explained for the embodiment shown in FIG. 1.

It is noted that in FIG. 9, all clients 110 are shown to have a part of the distributed cache 140 by way of non-limiting example only. It is for instance equally feasible to have a mixed or hybrid architecture in which some of the clients 110 comprise a distributed cache 140 and some other clients 110 rely on the distributed cache 140 in the server 120 to retrieve cached decisions. It will be recognized that one of the attractions of employing a distributed cache 140 is that are different types of clients 110 may be paired with a server 120, thereby increasing the flexibility of the system 900.

At this point it is noted that in case of a change to the rule set employed by the rule engine 222, the decisions that are stored in the decision cache may no longer be valid, for instance because these decisions were made based on a set of rules that are no longer in existence. Therefore, in an embodiment, a change to the rule set triggers the flushing of the decision cache, e.g. decision cache 114, decision cache 124 or distributed decision cache 140. As will be readily understood by the skilled person, such a change to the rule set will also invoke the execution of the rule set analyzer 212 in order to determine the relevant parameters of the new rule set, which newly determined relevant parameters may be used to build up and utilize the decision cache as previously explained. The analysis of the new rule set may be performed at any suitable point in time, e.g. after flushing the decision cache.

In the aforementioned embodiments, it will be understood that the rule set analyzer 212 is typically executed once, i.e. at initialization of a decision reuse process, in order to generate the decision request filter 214, key generator 216 and decision response filter 218 as previously explained. Therefore, although in the aforementioned embodiments the rule set analyzer 212 is shown to be located on the device comprising the decision cache, it will be understood that in at least some advantageous embodiment the rule set analyzer 212 is located elsewhere, e.g. outside the system-oriented architecture deploying the decision making service. For instance, the rule set analyzer 212 may form part of the authoring environment from where a rule developer writes and deploys a rule set for use in a decision making process. Such an authoring or development environment may be hosted outside the service oriented architecture, in which case the decision request filter 214, the key generator 216 at a decision response filter 218 may be provided as modules generated (by the rule set analyzer 212) during the design phase of the decision making service, which modules implement the desired decision reuse functionality. In this scenario, the presence of the rule set analyzer 212 is not required within the service-oriented architecture deploying the decision making service.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

As will be appreciated by one skilled in the art, aspects of the present invention may be embodied as a data processing system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable storage mediums(s) having computer usable program code embodied thereon.

Any combination of one or more computer readable storage medium(s) may be utilized. The computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present invention are described with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart, illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method, in a data processing system, of making a decision in a service oriented architecture, the method comprising:
receiving, by a processor in the data processing system, a request for a decision service, wherein the request comprises a plurality of user-defined parameters;
generating, by the processor, a key based on relevant parameters in the plurality of user-defined parameters, wherein the relevant parameters are parameters to be used by a rule set in making the decision;
using, by the processor, the rule set to make the decision;
storing, by the processor, the key and the decision in a cache; and
returning, by the processor, the decision to a source of the request.

2. The method of claim 1, further comprising:
evaluating, by the processor, the rule set for making the decision to determine the relevant parameters.

3. The method of claim 1, further comprising:
receiving, by the processor, a further request for the decision service, wherein the further request comprises a further plurality of user-defined parameters;
retrieving, by the processor, relevant further parameters from the further plurality of user-defined parameters to be used by the rule set in the decision making process;
generating, by the processor, a further key based on the relevant further parameters in the further plurality of user-defined parameters; and
searching, by the processor, the cache to find a match between the further key and the keys identified in the cache.

4. The method of claim 3, further comprising:
retrieving, by the processor, the decision from the cache identified by the key upon detecting a match between the key and the further key; and
returning, by the processor, the retrieved decision to the source of the further request.

5. The method of claim 3, further comprising:
using, by the processor, the rule set to make a further decision if none of the keys in the cache match the further key;
storing, by the processor, the further key and the further decision in a the cache; and
returning, by the processor, the further decision to the source of the further request.

6. The method of claim 1, further comprising:
replacing, by the processor, parameters of the plurality of user-defined parameters that are irrelevant to the decision making process with wildcards in the decision; and
storing, by the processor, the decision including the wildcards in the cache.

7. The method of claim 1, further comprising:
flushing, by the processor, the cache upon a change to the rule set.

8. The method of claim 7, further comprising:
evaluating, by the processor, the changed rule set to determine the relevant parameters in the plurality of user-defined parameters to be used by the changed rule set in the decision making process.

9. A computer program product comprising a computer-readable storage medium having a computer readable program stored therein, wherein the computer readable program, when executed on a computing device, causes the computing device to:
receive a request for a decision service, wherein the request comprises a plurality of user-defined parameters;
generate a key based on relevant parameters in the plurality of user-defined parameters, wherein the relevant parameters are parameters to be used by a rule set in making a decision;
use the rule set to make the decision;
store the key and the decision in a cache; and
return the decision to a source of the request.

10. A data processing system comprising:
at least one processor; and
a memory coupled to the at least one processor, wherein the memory comprises instructions which, when excepted by the at least one processor, cause the at least one processor to;
receive a request for a decision service, wherein the request comprises a plurality of user-defined parameters:
generate a key based on relevant parameters in the plurality of user-defined parameters, wherein the relevant parameters are parameters to be used by a rule set in making a decision;
use the rule set to make the decision;
store the key and the decision in a cache; and
return the decision to a source of the request.

11-15. (canceled)

16. The data processing system of claim 10, wherein the instructions further cause the at least one processor to:
evaluate the rule set for making the decision to determine the relevant parameters.

17. The data processing system of claim 10, wherein the instructions further cause the at least one processor to:
receive a further request for the decision service, wherein the further request comprises a further plurality of user-defined parameters;
retrieve relevant further parameters from the further plurality of user-defined parameters to be used by the rule set in the decision making process;
generate a further key based on the relevant further parameters in the further plurality of user-defined parameters; and
search the cache to find a match between the further key and the keys identified in the cache.

18. The data processing system of claim 10, wherein the instructions further cause the at least one processor to:
replace parameters of the plurality of user-defined parameters that are irrelevant to the decision making process with wildcards in the decision; and
store the decision including the wildcards in the cache.

19. The data processing system of claim 10, wherein the instructions further cause the at least one processor to:
flush the cache upon a change to the rule set.

20. The data processing system of claim 19, wherein the instructions further cause the at least one processor to:
evaluate the changed rule set to determine the relevant parameters in the plurality of user-defined parameters to be used by the changed rule set in the decision making process.

21. The computer program product of claim 9, wherein the computer readable program further causes the computing device to:
evaluate the rule set for making the decision to determine the relevant parameters.

22. The computer program product of claim 9, wherein the computer readable program further causes the computing device to:
receive a further request for the decision service, wherein the further request comprises a further plurality of user-defined parameters;
retrieve relevant further parameters from the further plurality of user-defined parameters to be used by the rule set in the decision making process;
generate a further key based on the relevant further parameters in the further plurality of user-defined parameters; and
search the cache to find a match between the further key and the keys identified in the cache.

23. The computer program product of claim 9, wherein the computer readable program further causes the computing device to:
replace parameters of the plurality of user-defined parameters that are irrelevant to the decision making process with wildcards in the decision; and
store the decision including the wildcards in the cache.

24. The computer program product of claim 9, wherein the computer readable program further causes the computing device to:
flush the cache upon a change to the rule set.

25. The computer program product of claim 24, wherein the computer readable program further causes the computing device to:
evaluate the changed rule set to determine the relevant parameters in the plurality of user-defined parameters to be used by the changed rule set in the decision making process.
